(19) United States
(12) Patent Application Publication
(10) Pub. No.: US 2006/0063139 A1
(43) Pub. Date: Mar. 23, 2006

(54) Computer assisted reading tutor apparatus and method

(76) Inventors: Ronald P. Carver, Kansas City, MO (US); Mary Louise Carver, Kansas City, MO (US); John M. Holliday JR., Leawod, KS (US)

Correspondence Address: Mark Manley, Dockery Suite 102, Central Missouri State University, Warrensburg, MO, 64093, US

(21) Appl. No.: 10/948,726

(22) Filed: Sep. 23, 2004

(51) Int. Cl. G09B 17/00

(52) U.S. Cl. 434/178

(57) ABSTRACT

A method and apparatus for teaching readers including providing a placement spelling, placement listening vocabulary and speed test through a computer. A speed coefficient based on results from the placement tests is computed. A starting word list is determined based on the results of the tests. A listening vocabulary skill score is compared to a spelling skill score to determine a teaching program to present through the computer. The method includes a vocabulary loop, a spelling loop and a speed test applied to the word list and wherein the speed test results determine the value of the coefficient applied to a next word list.

### RELATED APPLICATIONS

None

### BACKGROUND OF THE INVENTION

In education it is often necessary to provide remedial reading assistance to students. Sometimes these students have fallen behind their age peers and other times they may be students learning a foreign language.

In order to understand the complete thoughts in sentences while reading normally, a reader must know the meaning of the individual words in the sentence. A word whose meaning is known by the reader and can be recognized accurately and quickly in print will be called a “raudamatized” word. A raudamatized word can be read automatically or fluently.

A fundamental idea is that teachers need to help typical students learn to raudamatize about 5 new words each day of school—from grade 1 through grade 7. This means that students who do not learn to raudamatize about 5 new words each day of school will have a major problem by the time they reach the eighth grade of school; they will not be able to comprehend most sentences written at the 8th grade level of difficulty. Typical students will learn to raudamatize 5 new words each day of school, on the average, but poor readers will not.

Teaching reading is currently an intensive time consuming effort for teachers because they tend to need to work one on one with students to compensate for the different learning types and weaknesses. Often students simply get left behind.

As can be seen there is a need for a reading system that is easy to install and use. There is further a need for a system to aid in the instruction of reading, spelling and vocabulary based on the present reading level of the student.

### SUMMARY OF THE INVENTION

The present invention relates to a computer based method of teaching readers that varies the content and approach to teaching depending upon the knowledge of the student and upon the learning style of the student. The method includes providing a placement test of a student's spelling and vocabulary skills through a computer. The method includes setting a speed coefficient based on results from the test and providing a set of word lists containing basic reading words. The method sets a starting word list value based on the results of the test and compares a vocabulary score to a spelling score to determine a comparison and the method determines a teaching loop to present through the computer based on the comparison. The system then presents the teaching loop for the words in the starting word list.

The present invention further provides a program that rapidly teaches word recognition by having students examine a learned list of words to distinguish those words that are unchanged from those with vowels and or consonants that have been randomly altered.

These and other advantages of the present invention will become apparent from the detailed description of the invention.

### BRIEF DESCRIPTION OF THE DRAWINGS

FIG. 1 shows an overview of the entire main sequence, beginning with three placement tests and then looping through the Tutor once for each List.

FIG. 2 is the graduated reading sequence followed for each List.

FIG. 3 is the Spelling tutor Program,

FIG. 4 shows one possible computer system,

FIG. 5 is the Vocabulary tutor Program,

FIG. 6 shows an example vocabulary training,

FIG. 7 is the Spelling loop sequence,

FIG. 7a sample spell learning

FIG. 8 is the Special Vocabulary loop,

FIG. 8A shows a sample vocabulary test

FIG. 9 is the Vocabulary loop,

FIG. 10 is the Speed loop,

FIG. 10A is a sample speed test,

FIG. 11 shows the vocabulary review,

FIG. 12 shows an example collection of word lists,

FIG. 13 shows the special topics sequence,

FIG. 14 shows an example collection of topic word lists,

FIG. 15 shows a screen shot of feedback preferences.

### DETAILED DESCRIPTION OF THE DEVICE

Students who read poorly and who know more words when listening than when reading have been labeled Poor Type I Readers. These students are likely to be average or above in their aptitude for learning the meaning of spoken words. That is, they can learn words when they hear them but they have a great deal of trouble learning to read words in print. They are likely to have a low aptitude for learning the correspondences between the letters within words and sounds within words. For example, a Poor Type I Reader is likely to learn the meaning of the spoken word “horse” relatively easily, but learning to say “horse” when seeing this word in print is much more difficult.

Students who have an extremely low aptitude for learning to pronounce new printed words are often called “dyslexics,” or they are said to have a “reading disability.” Again, this low aptitude for learning sound-symbol correspondences is likely to be the main reason for being a Poor Type I Reader. This low aptitude will make them slow in learning to pronounce new words that they already know when listening. Therefore, these students will score below average on word identification tests where they are given a list of words that range in difficulty, and are asked to pronounce them accurately.

Students who read poorly and know as many words when reading as when listening have been labeled Poor Type II Readers. These students are likely to be below average in their ability to learn verbal information, that is, they have trouble learning from being told. These are the students who have to be told something many times before they understand it, or learn it. However, Poor Type II Readers may be average or above in spelling aptitude or pronunciation aptitude.

This aptitude for learning by listening, or learning from being told, will be called “verbal aptitude.” So, low verbal aptitude is likely to be the main cause for being a Poor Type II Reader. Low verbal aptitude means that a student takes longer than average to learn new words and ideas when listening. Therefore, a student with low verbal aptitude is likely to have a lower than average listening level, and to have a lower than average listening vocabulary. This low listening vocabulary will cause a lower than average reading level (and a lower than average reading vocabulary) because it is harder to raudamatize new words when their meanings are not known when listening. A word whose meaning is known by the reader and can be recognized accurately and quickly in print will be called a ‘rautamatized’ word. It is harder to raudamatize new words each day when the meaning of these words are unknown when listening. Also, a lower than average reading vocabulary (or a lower than average reading level) will cause lower than average reading achievement. This means that a student with a lower than average reading vocabulary will likely obtain a lower than average score on a reading achievement test. In summary, a low verbal aptitude causes low reading achievement because it causes lower than average listening vocabulary, lower than average reading level, and lower than average reading vocabulary. Prior attempts to develop devices to assist in teaching reading, spelling and vocabulary skills fail to take into account the different learning requirements of students.

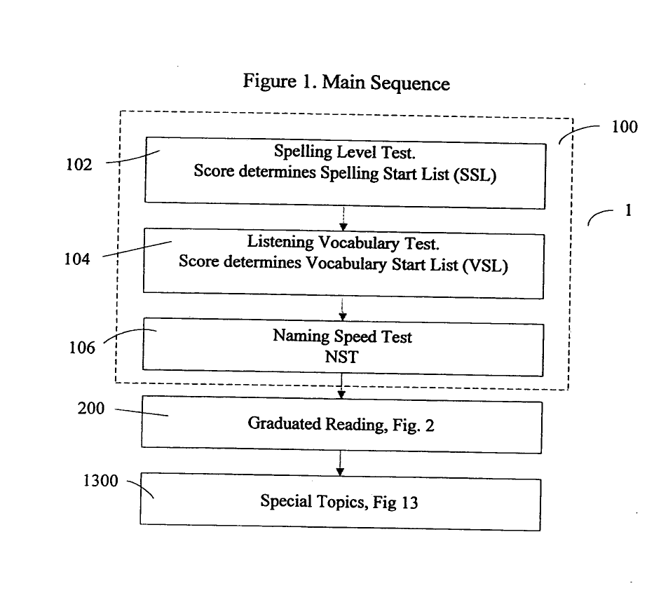

FIG. 1 shows the main program sequence 1 including a placement test portion 100 used to place students start on a certain list L of words. The placement test portion 100 can include three separate tests, a placement spelling test 102, a placement vocabulary test 104 and a naming speed test 106.

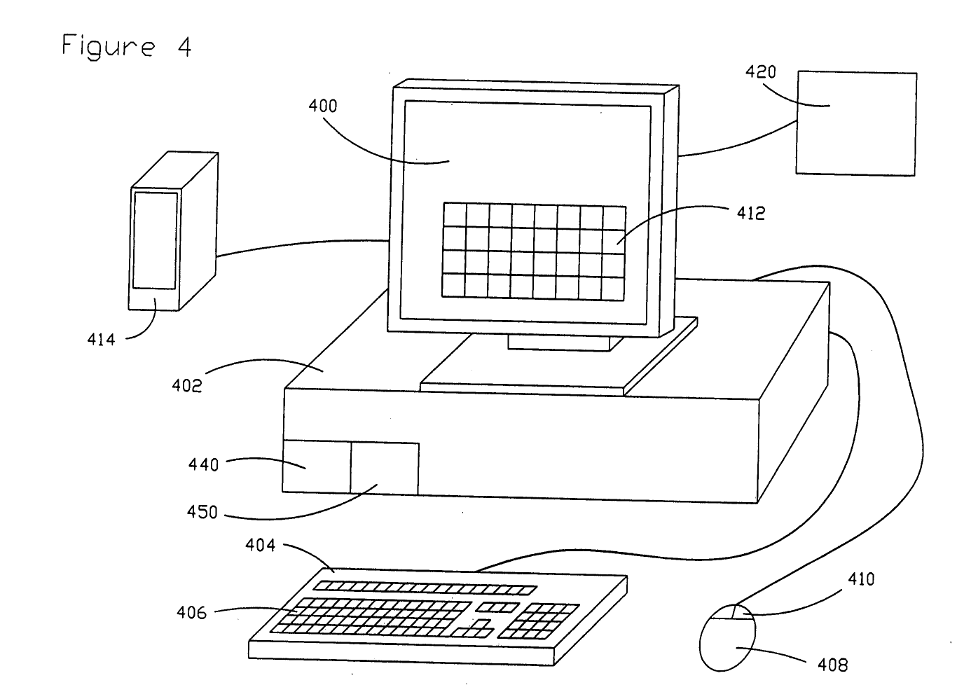

The Placement Spelling Level Test 102 measures how many words a student can correctly spell and sets a spelling start list (SSL) for the tested student. Referring to FIGS. 1 and 4, on the spelling level test 102, the word is pronounced aloud by the computer 402 using for example a speaker 414, and the student can spell the word by using a mouse 408 to click on a field of letters 412 on the computer screen 400, or by pressing the letter keys 406 on the computer keyboard 404 to spell the word the student heard. It will be understood that a computer 402 could be a personal computer, a network computer, a laptop computer, a mainframe terminal, a hand held computer or any device capable of operating the method. The raw score on the Placement Spelling level test 102 is also converted into a particular score indicating a spelling start list (SSL) of basic words that the student could start on. For example, there can be 184 lists of 50 words comprising the 9200 basic words a student can have raudamatized in order to read material written at the 12 grade level of difficulty. For example, suppose a student Lori had a raw score of 18 on the Spelling level test 102. This would convert into List 39, indicating that she could spell and pronounce the easiest 1,900 basic words (38×50=1,900).

The placement Listening Vocabulary Test 104, can have 100 questions for example. Each question consists of a target word, such as “look,” and three alternative answers, such as “run,” , “see,” and “jump.” The student selects the answer that means about the same as the target word “look”, which in this example is “see.” The target word and the 3 answers are presented on the computer screen 400, and are also read aloud to the student by the computer 402. So the program measures listening vocabulary by reading aloud target words and multiple choices of synonyms. If the student knows the meaning of the word by listening, then the student does not have to be able to read the words in order to select the correct answer. The words on the Listening vocabulary test 104 have been sampled from curriculum materials, and they increase in difficulty from very easy to very difficult. This can be an adaptive test, so all 100 questions need not be asked because (a) a basal can be established so all of the easy questions are not asked, and (b) a ceiling can be established so all the hard questions are not asked. The raw score on the Listening vocabulary test 104 provides an estimate of the number of words the student knows when listening; it is also converted into a particular 50-word list, the vocabulary start list (VSL) of basic words. For example, suppose a girl named Lori was a poor reader who scored 31 on the Listening vocabulary test 104. This score of 31 could be converted into Grade Equivalent (GE)=4.5, which would indicate that Lori's listening level was fourth grade. And, this raw score of 31 would translate into a VSL value of 80, which would indicate that Lori would likely know the meaning of 3,950 basic words when listening to them, that is, all the words in Lists 1 through 79 (79×50=3,950).

In the above example, Lori would be a Poor Type I Reader who would need to learn to spell and pronounce the 2,050 words in Lists 39 through 79 in order to be able to read as well as she can listen. A Type I reader can spell and pronounce fewer words than they can understand when listening. Type I readers are the most common. Lori would start working on a starting word List 39 in the Spelling Tutor; her starting List for the Vocabulary Tutor would be List 80. On the other hand, if Lori's score on the SLT had indicated a starting word list of 80 or higher for the Spelling Tutor, she would have known as many words when reading as when listening. Then, she would have been a Poor Type II Reader, and she would start working on List 80 in the Vocabulary Tutor.

So, the comparison between the scores on the Listening vocabulary test VSL and the Spelling level test SSL determines whether a student is a Poor Type I Reader or a Poor Type II Reader, and also determines whether the student will start working on the Spelling Tutor or the Vocabulary Tutor. This comparison occurs in steps 104 and 204 and can be stored in computer memory 450. The Naming Speed Test 106, to be described next, has nothing to do with whether a student is a Poor Type I Reader or a Poor Type II Reader, and therefore may have nothing to do with the starting lists for the Spelling Tutor or the Vocabulary Tutor. Instead, it provides an indicator of naming speed which can be used to determine how long a student needs to practice on words before they are raudamatized, and can therefore be read at the students own reading rate (own speed limit). A raudamatized word can be read automatically or fluently.

The Naming Speed Test, NST 106, can consist of the following eight pairs of letters: aA, aB, bA, bB, Aa, Ba, Ab, Bb. These pairs are presented in lists with the order of the eight pairs randomized. The task for the student is to press one key if the pair of letters has the SAME name (aA, Aa, bB, Bb) and to press another key if the pair of letters has a DIFFERENT name (aB, bA, Ba, Ab). And, the student is supposed to do this naming of letters as fast as possible. There can be a penalty for guessing wrong. This naming speed score can be used later to establish a speed coefficient to be used for a student, as will be explained later. So the program measures naming speed by presenting pairs of symbols or letters in a combination of upper and lower case where a student distinguishes that both symbols are the same or the two are different.

Referring to FIG. 1, after the student has completed the test portion 100 the student will be placed at a starting word list L based on the test result. The starting list L can be set to the smaller of SSL and VSL at listening vocabulary test 104. The program main sequence 1 then presents the graduated reading sequence 200 where the student will work through a series of basic word lists L stored in a database 440 in computer 402 (see FIG. 4). Upon completion of the basic word lists L the student can move to a special topics tutor 1300 that might present special words needed for reading in a specific topic area such as math or science.

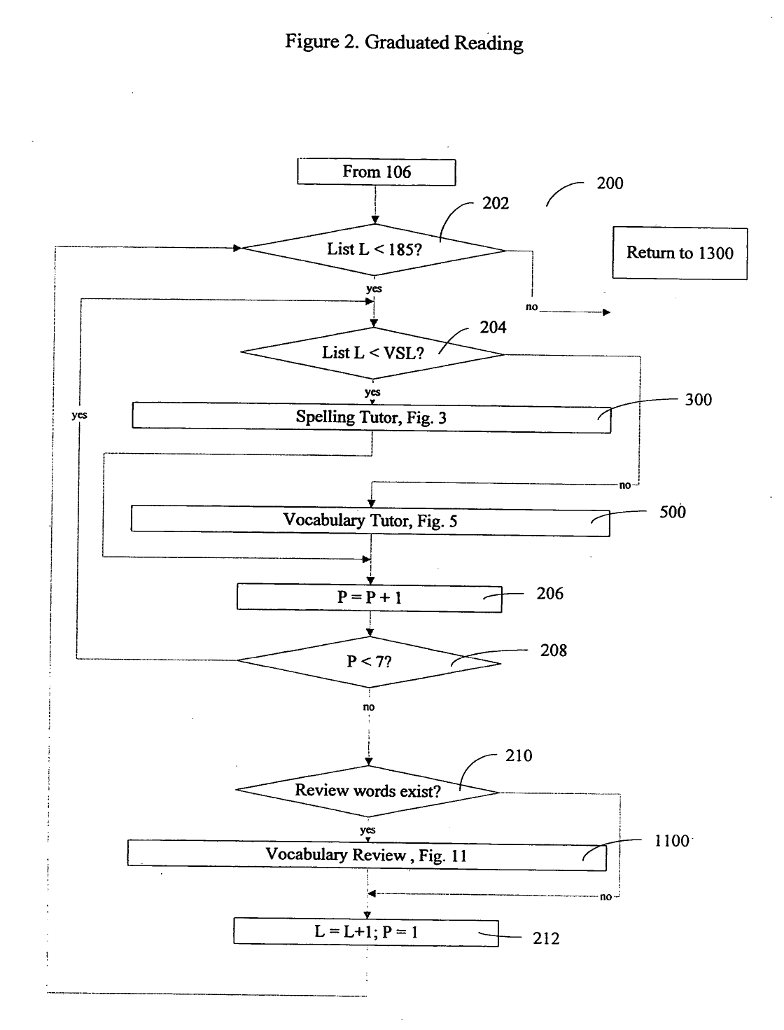

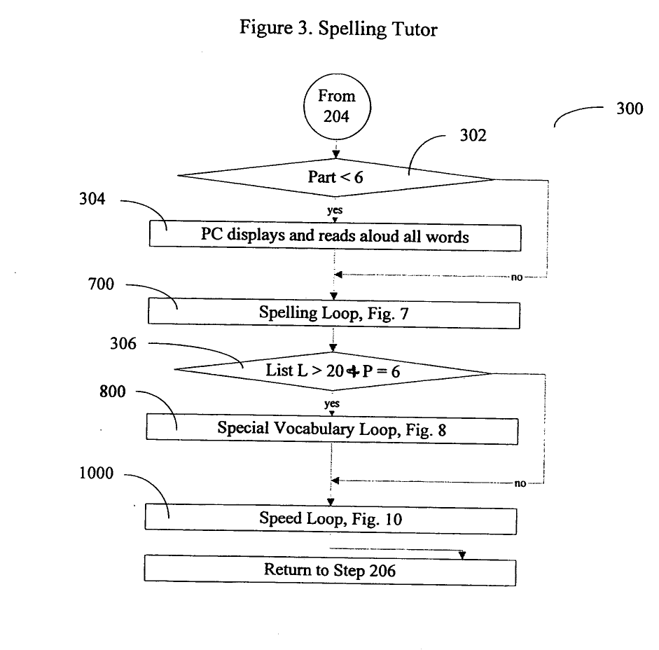

FIG. 2 shows details of the graduated reading sequence 200 for a list L. Each list L contains a number of words, 50 for example. A given list L with 50 words can be broken up into 5 parts, P each part P 1-5 containing 10 words. Also a final part, P=6 can be set as a part containing the entire list of 50 words. The graduated reading sequence 200 begins with comparison step 202 where the list number L is compared to the total number of lists available. In the example, there are 184 lists available so if L is less than 185 the graduated reading sequence 200 will proceed to present the L list for the student. When L equals 185 that indicates that the student has mastered the spelling and listening skills for all 184 lists of 50 words. The graduated reading sequence 200 is finished at L=185 but the student can proceed to special topics word tutor 1300. The list L is compared in comparison step 204 to VSL and if less, then the spelling tutor sequence 300 is presented, see FIG. 3 for details of the spelling tutor sequence 300. Once the Spelling tutor sequence 300 is complete the part P is indexed in index step 206 to P+1 and if P is less than 7 in comparison step 208 the spelling tutor sequence 300 for the next part P is selected. If P is 7 in comparison step 208 then the graduated reading sequence 200 checks in check step 210 for vocabulary review 1100 words, if there are no review words then the graduated reading sequence 200 indexes in index step 212 L to L+1 and resets P=1 and returns to comparison step 202. If L>VSL then the same procedure is followed except the vocabulary tutor 500 is used in place of the spelling tutor sequence 300.

FIG. 3 shows details of the spelling tutor sequence 300. The part P is compared in comparison step 302 to 6. If P is less than 6, then the spelling tutor sequence 300 proceeds to the P part of list L and the computer 402 displays and reads in reading step 304 all words in part P. The spelling tutor sequence 300 then administers a Spelling loop 700 for the 10 words in part P. In comparison step 306 the spelling tutor sequence 300 compares part P to 6 and the List L to 20 for example. In this case the lists L less than 20 contain very basic words such as “a” and “I” and these words do not have a Special Vocabulary loop 800 so the special vocabulary loop 800 is skipped if L<20. If L >20, and P=6 indicating that we are working on the List L as a whole, then the special vocabulary loop 800 is administered for the 50 words read from list L. The spelling tutor sequence 300 then administers the speed loop 1000 for the P words. Finally the spelling tutor sequence 300 returns the program to step 206.

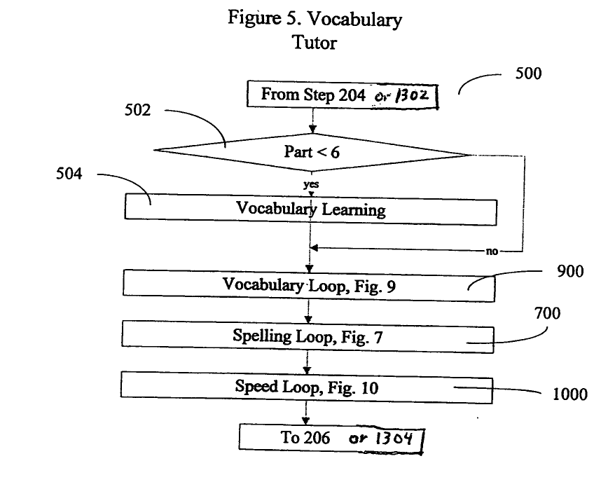

FIG. 5 shows the vocabulary tutor sequence 500. If the part P is less than 6 then the vocabulary tutor sequence can apply vocabulary learning 504 to assist the student in learning the new words in part P. The Vocabulary tutor sequence 500 then applies the vocabulary loop 900, spelling loop 700 and speed loop 1000 for the P part of list L and returns the student to index step 206 of the graduated reading sequence 200.

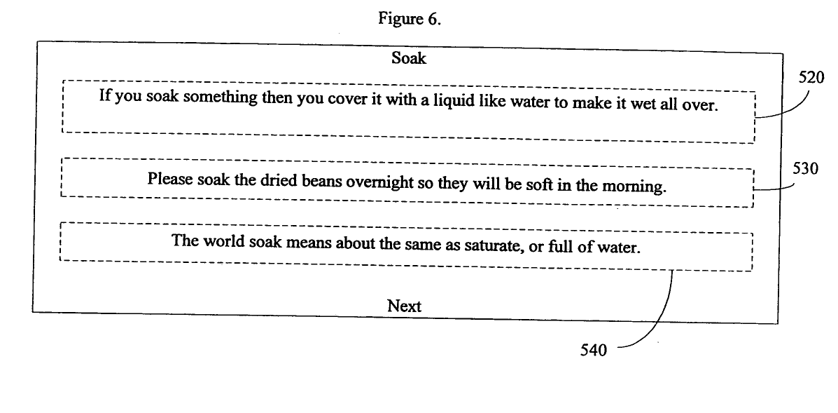

FIG. 6 shows a sample vocabulary learning for an example word ‘soak’. Once the student is to the point where the list L is equal to or greater than the VSL score for the student in step 204, then the program must teach the student vocabulary use of the words as well as spelling. In FIG. 6 the computer 400 both shows and reads aloud the word ‘soak’, and may present or read aloud a description such as definition 520, an example 530 of how the word soak might be used in a sentence and synonym sentence 540. The student can then indicate ‘next’ to display the definition 520, example 530, and synonym 540 for the next word in part P until all the words in part P have been displayed.

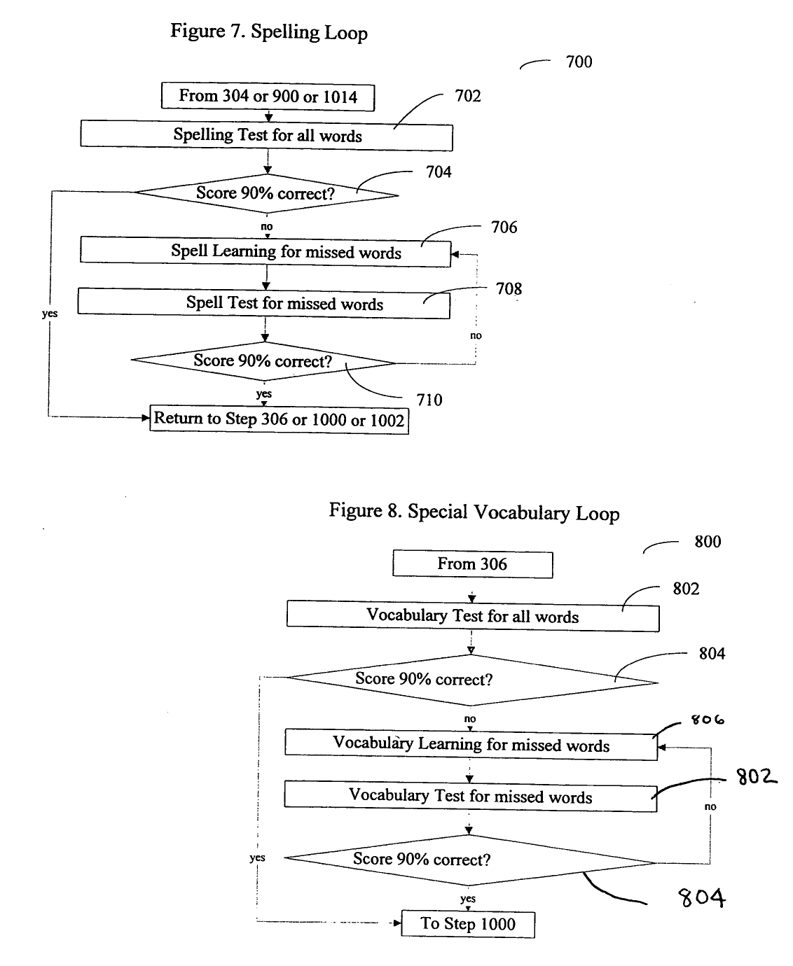

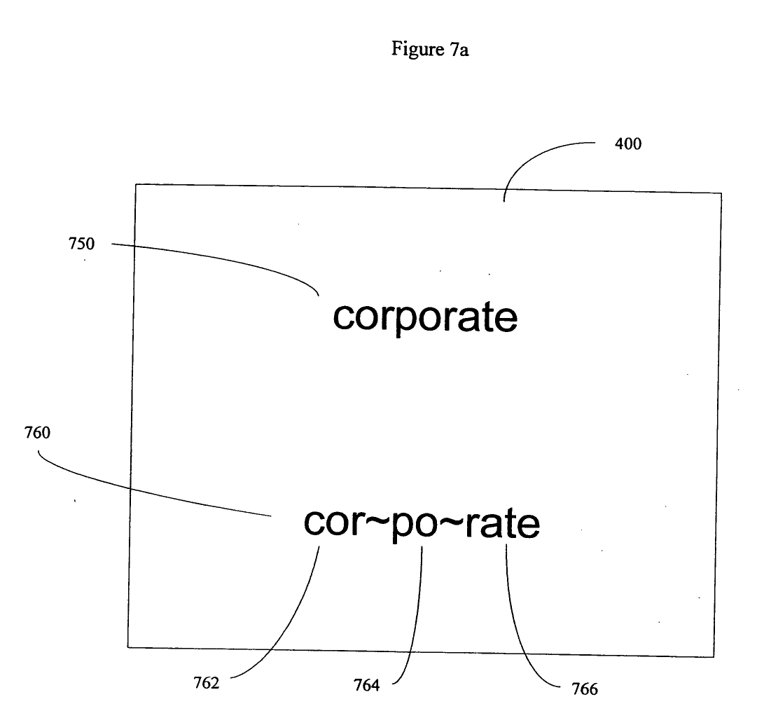

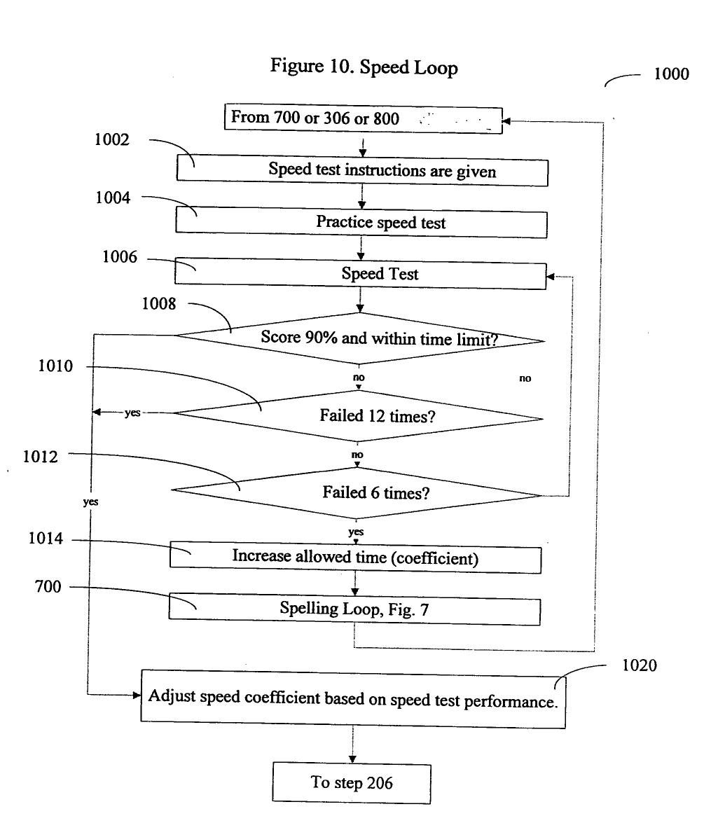

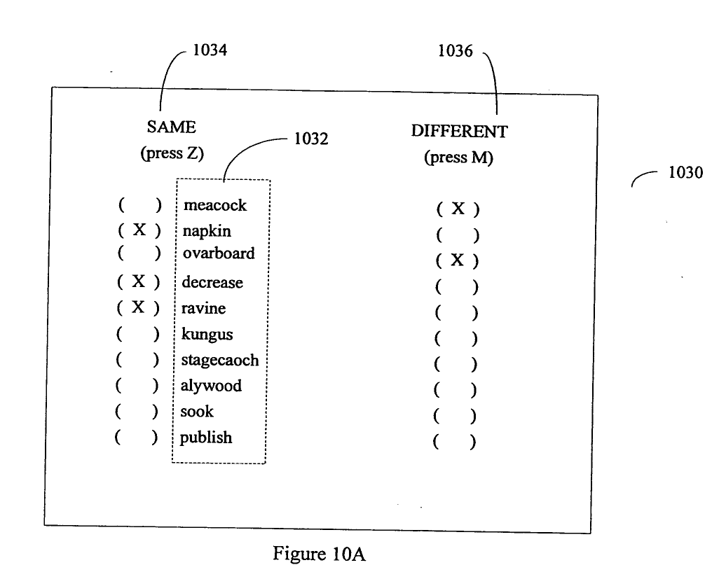

FIG. 7 displays the spelling loop 700. In the spelling tutor sequence 300 shown in FIG. 3 after the computer 400 reads the words from a part P aloud it then starts the spelling loop 700. In the spelling loop 700, the student will take the spelling test 702 where the student will attempt to spell each of the 10 or 50 words. The student can use the keyboard 404 or mouse 408. The computer 400 can verbally prompt the student for each word. If the student spells 90% of the words correctly then the step 704 returns to step 306 or 1000 or 1002 depending upon how the student branched to the loop 700. If the student spells less than 90% then the spelling loop represents 706 the missed words so that the student can learn to spell the missed words. The student is then tested 708 for just the missed words and if the cumulative score rises to 90% then the student is again returned to step 306. If the score is less than 90% then the student continues to loop back until the score is 90%. The spelling loop 700 is also used in the vocabulary tutor 500 and in the speed loop 1000 to be explained in reference to FIG. 10.

FIG. 7a shows an example screen shot for how spell learning step 706 is applied to the word ‘corporate’. First the word ‘corporate’ 750 is displayed on the computer screen 400. Then the word ‘corporate is read aloud by the computer 402. Then the word ‘corporate’ can fade and the syllable separated word ‘cor˜po˜rate’ 760 can appear and the computer 402 will read the syllable separated word ‘cor˜po˜rate’ by reading each syllable separately with a pause between the syllables.

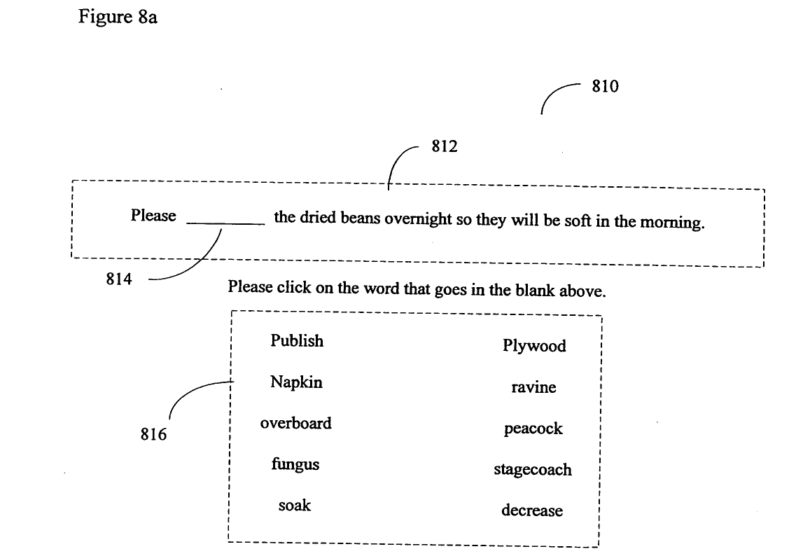

FIG. 8 shows details of the special vocabulary loop 800. In the spelling tutor 300, at the end of studying each list L the student is tested 802 for understanding of the meaning of at least some of the words from the list L in the special vocabulary loop 800. FIG. 8A shows a sample test 810 for the word ‘soak’. The sample test 810 can include a sentence 812 including a blank 814. The test can include a plurality of possible words 816 and the student can choose the correct word to fill in the blank from the list of words 816. If the student scores at least 90% correct 804 then the student proceeds to the speed loop 1000.

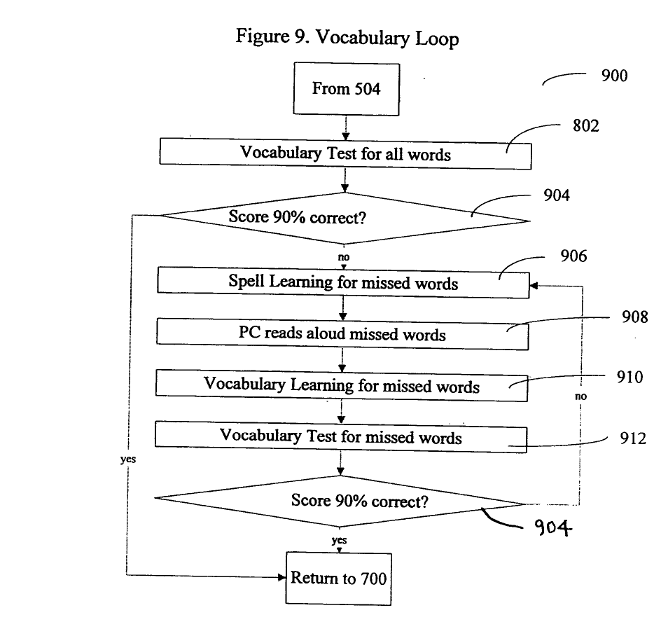

FIG. 9 shows the vocabulary loop 900. The vocabulary loop 900 begins by administering the vocabulary test 802 for all words similar to the sample from FIG. 8a. If the student scores 90% correct or more 904, the student is taken to the spelling loop 700. If the student scores less than 90% then the loop 900 presents spell learning 906 (see example FIG. 7a) for the missed words, and then the computer 400 reads the missed words aloud in read step 908. The loop 900 then presents vocabulary learning 910 for the missed words and then retests 912 the missed words. If the student then scores 90% or more in step 904 then loop 900 returns to loop 700, if the student scores less than 90% then the student is returned to spell learning 906.

FIG. 10 illustrates the speed loop 1000. From the spelling loop 700 the speed loop 1000 begins. The speed loop can begin with instructions 1002 given by the computer 400. Then the student can take a practice speed test 1004. FIG. 10a shows a sample speed test 1030. After taking the practice speed test 1004 the student can then be given the actual speed tests 1006 containing some or all of the words in a part. Some words will be spelled correctly and some can be misspelled. The student receives a score 1008 and if that score is 90% or above within the time limit based on the coefficient originally assigned for the student in the naming speed test 106, then if the student passes, the coefficient can be adjusted 1020 and the student leaves the speed loop 1000. If the student fails, the loop 1000 checks how many times the student has failed the speed test 1006, if more than 12 the students coefficient is adjusted to allow more time and the student is returns to step 206. If the student has failed more than 6 times the student's speed coefficient is increased to allow slightly more time next time, and the student returns to repeat the spelling loop 700. If the student has failed less than 6 times then they return to the speed test 1006 and repeat.

FIG. 10a shows sample speed test 1030 containing list words 1032 and areas to check for correct (same) 1034 and incorrect (different) 1036 spelling of each word. The student will check each word as correct or incorrect as quickly as they can. The student's speed coefficient adjusts the program time allowed to the natural speed of the student.

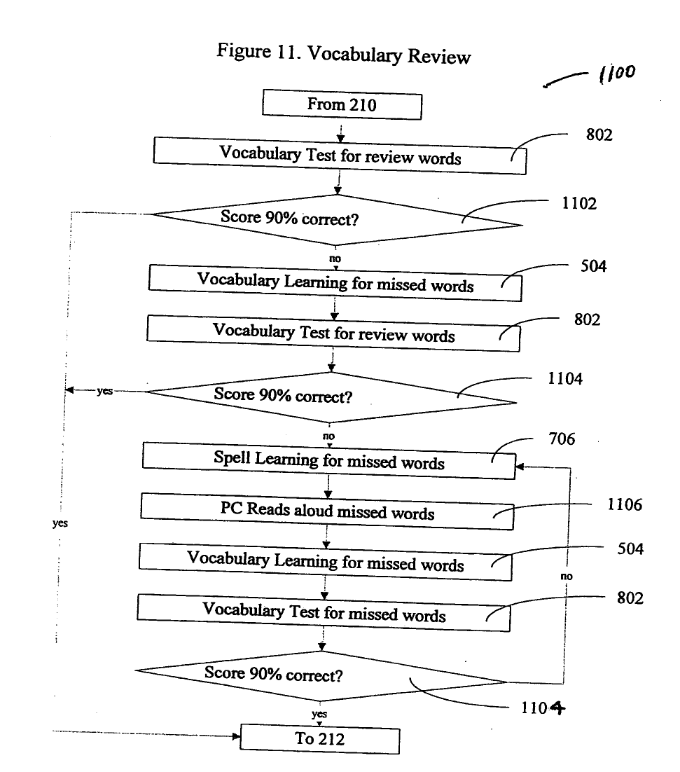

FIG. 11 details the vocabulary review loop 1100. From step 210 of the graduated reading 200, the student is given the vocabulary test 802 for review words. If the score 1102 is greater than 90% the student is returned to step 212 of the graduated reading. If the score 1102 is less than 90% the student goes thru a vocabulary learning step 504 for the review words missed and repeats the vocabulary test 802 for the review words. Again a score 1104 of 90% or above takes the student back to step 212. A score below 90% returns the student to spell learning 706 for the missed words, the computer 400 reads the words aloud 1106 and the student receives vocabulary learning 504 for the missed words. The student is then again given the vocabulary test 802, a score 1104 above 90% returns the student to step 212, a score 1104 below 90% and the student is looped back to spell learning 706 for the missed words.

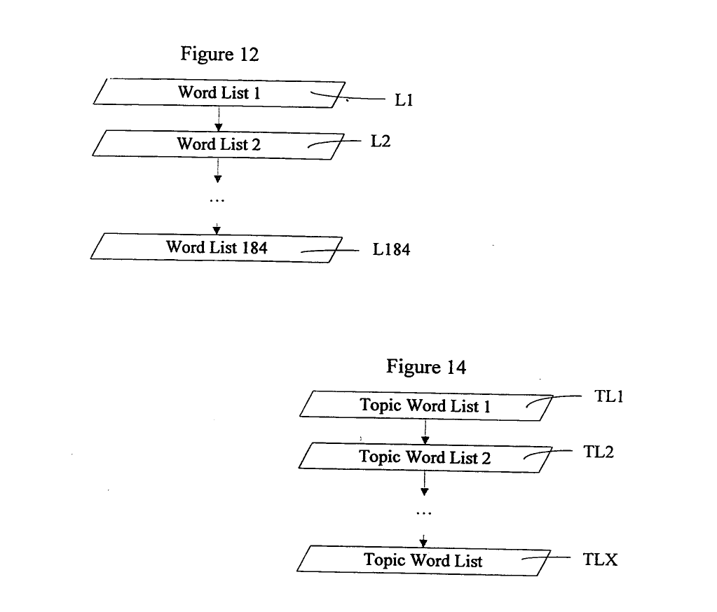

FIG. 12 illustrates that the program contains multiple word lists L, the specific example contains 184 word lists of 50 words each. Each 50 word list L can be broken up into 5 parts P each containing 10 words each and a 6^{th} part containing all 50 words. This gives the student a vocabulary learning list of just over 9000 words, which is approximately the number of words needed to read at a high school grade equivalent level. It will be understood that each subsequent list can contain words of increasing difficulty with the final list containing the most difficult words to learn. It will be understood that these are examples and that various numbers of lists containing various numbers of words could be used.

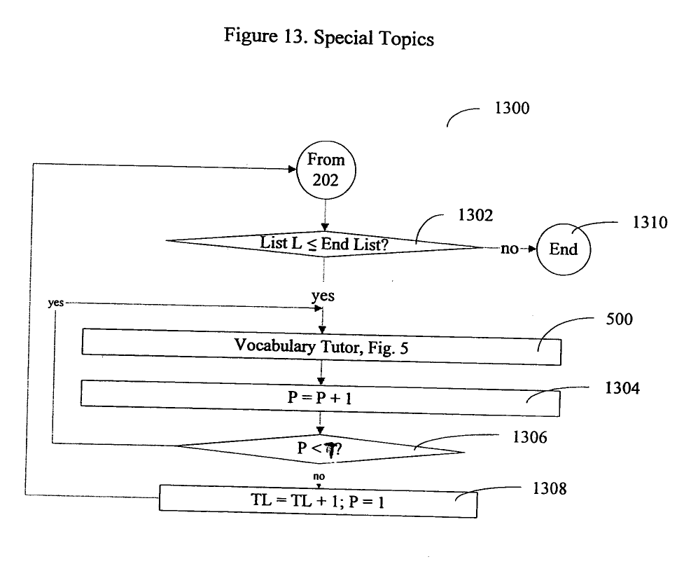

FIG. 13 illustrates the special topics loop 1300. After a student has mastered the basic word lists L, they may want to proceed to learn specialized word from fields such as math, science or music for example. The special topics loop 1300 can present topic word lists, see FIG. 14. The special topic loop 1300 begins by checking which topic list TL the loop 1300 is on, the loop begins with TL1. If the loop 1300 has more lists then it proceeds to the vocabulary tutor 500 for the topic list TL. Again each topic list TL can contain 50 words divided into 5 parts P so that the loop 1300 indexes 1304 through to the next part P+1 after each part P is complete. The loop 1300 checks 1306 after each part P if that is the final part. If P is 7, then the loop 1300 indexes 1308 to the next topic list TL.

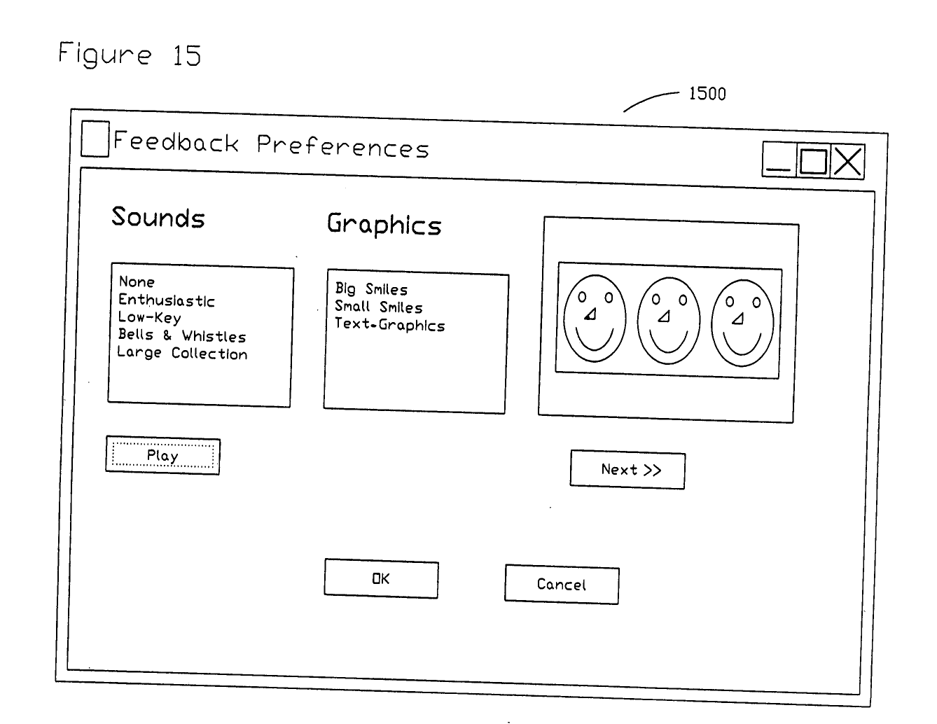

FIG. 15 shows a screen shot 1500 that can allow the program student feedback to be set. For example, an instructor may set the program to provide verbal praise and graphic images for young learners for each correct answer for example, while the audible feedback for adults can be set low key or none at all, and with suitable graphic feedback.

In Operation

In operation, and referring to all Figures, a student can use a computer to start the main sequence 1 of a program for vocabulary, spelling and reading learning. An advantage of the program is that once a student begins, the program is self paced. Each loop is presented in such a way that the student does not need assistance. This means a single instructor can manage dozens of students. The program can exist on a network platform 420 such as an internal network, inter-network or the Internet such that many students can access and use the program. Students can input data into the computer 400 via input devices such as a mouse 408 or keyboard 404. Students with special needs could use accommodations such as a head pointer or an eyegaze computer depending upon their needs. The coefficient that is set for each student adjusts the speed loops for the natural speed of a student such that a student with special needs can use the program.

The program has a natural flow proceeding from the tests 100 in FIG. 1 on through the lists L and then on to the special topic lists TL. The program can remember where a specific student leaves off so that the student can start back where they left off. With over 9000 words to learn the program can take several semesters or years for a student to master. It is also possible for the student to jump into the program at different points, for example a student or instructor could set the list to a value of L=50 and start there without taking the tests 100. This gives some flexibility to how a student or instructor might use the program in certain circumstances.

For Poor Type I Readers, knowing the main cause of their reading problem is not very important from the standpoint of the type of instruction to be given. The most effective instruction is to help them learn to spell, pronounce, and quickly recognize all the words they know when they hear them. That is, the most effective instruction will focus on (a) finding out which words the Poor Type I Readers know when listening but do not know when reading, (b) helping them learn to spell and pronounce these words, and (c) giving them enough practice so that these words can be recognized relatively quickly. This kind of instruction is extremely difficult for teachers because it is student specific, and therefore cannot be efficiently remediated by group instruction. These Poor Type I Readers really need a tutor in order to make the most gain during the school year. Yet, a classroom teacher has very little time to devote to a particular student while ignoring the rest of the class.

The lower the pronunciation aptitude, the longer it will take to turn a Poor Type I Reader into a Type II Reader. Also, the bigger the gap between the number of words known when listening and the number of words known when reading, the longer it will take for the system to help a Poor Type I reader become a Type II Reader. Furthermore, many Poor Type I Readers will have a listening vocabulary so low that when they become a Type II Reader, they then become a Poor Type II Reader.

Most Poor Type II Readers have low reading achievement because they have low verbal aptitude. This means that it takes them longer to learn verbal information, i.e., learn the meaning of new words and ideas. However, the root cause of being a Poor Type II Reader is not very important from the standpoint of the most effective type of instruction. All Poor Type II Readers have to raudamatize 5 new words each day on the average, in order to gain an average amount in reading achievement during the school year. This will be more difficult for these Poor Type II Readers to accomplish, as compared to Poor Type I Readers because the meanings of the new words must also be learned. About the only way for these students to raudamatize 5 new words each day is by tutoring. The system can help Poor Type II Readers increase their reading achievement by learning to read new words at their own pace and at a level appropriate for them based on the testing 100.

Spelling Tutor for Type I Readers.

A student who knows more words when listening than when spelling will work on the Spelling Tutor 300. For example, suppose the SLT score indicated that a student named Jose should start the Spelling Tutor on List 31; this would mean that Jose could spell the 1,500 basic words in Lists 1-30, but could not spell the 4,700 basic words in Lists 31 to 124. However, suppose the score Jose made on the LVT indicated that he knew the meaning of the 3,000 basic words in Lists 1-60; this would also mean that Jose should stop working on just the Spelling Tutor 300 after List 60 because Jose would not know the meaning of the 3,200 basic words in Lists 61 to 124. In addition, this would mean that when Jose reached List 61, then he would start working on the Vocabulary Tutor 500. So, in this example, Jose first needs to be given the Spelling Tutor 300 on the 1,500 basic words in Lists 31-60, that is, instruction that is appropriate for a Poor Type I Reader. Remember that this instruction using the Spelling Tutor will focus on learning to raudamatize these 1,500 basic words that are known when listening but cannot be recognized accurately and quickly when reading.

As noted in the example above, the student (Jose) would start working on List 31 in the Spelling Tutor 300 of the program. Each list L of 50 words is subdivided into 6 parts P, with 10 words in each of Parts 1, 2, 3, 4, and 5. First, each one of the 10 words in Part 1 is presented on the computer screen 400 and pronounced, one at a time. Then, a test 702 on these 10 words is given. The first word is pronounced and the student tries to spell it correctly by clicking on the appropriate letters on the computer screen 400, or by pressing the appropriate keys 406 on the computer keyboard 404. For example, the computer 402 might say “ample,” and the student would click on the letter “A,” then “M,” and so on, until the word was spelled. Then, the student could click on a “FINISHED” button. If the word is spelled correctly, then happy faces (see FIG. 1500) appear on the screen 400 and the computer says EXCELLENT, or FANTASTIC for example. Then, the Spelling Tutor 300 goes on to the next word and pronounces it.

If the student spells this word wrong, then negative feedback is given, for example a green monster can appear briefly on the screen 400 and a slightly irritating sound is emitted by the computer 402. Then, the next word is pronounced. In order to pass this test on the 10 words, a student must get 9 correct (90%) 704. If the test 702 is not passed, then the student must learn to spell the missed words. For example, if the student missed 5 words, then the first of the five words would be pronounced, and the student would attempt to spell it. This time when a word is spelled wrong, the correct spelling is given in spell learning 706, and the student must keep trying over and over, until it is spelled correctly. When the word is spelled correctly, the Spelling loop 700 goes on to the next word. When all 5 of these words in this example have been spelled correctly, then a test 708 is given on these 5 missed words. The student must get 90% correct to pass the test. If the test 708 is not passed then the ones that are missed must be worked on again, and another test given. This cycle is repeated until 90% are answered correctly on the test.

When the student has passed the Spelling Test 702 on the 10 words in Part 1, then a Speed Test 1000 is given on those 10 words. On the Speed Test 1000, the 10 words are presented on the screen 400 in a column 1032 FIG. 10a with one letter changed in 5 of the 10 words. The task for the student is (a) to press one key 406 when the word is spelled the SAME as it was when they learned it, and (b) to press another key 406 when the word is spelled DIFFERENT from the way they learned it. For example, students should press the key for SAME when they see “laugh” but if they see “lough,” they should press the key for DIFFERENT. They do this as fast as they can. Notice that this test is similar to the Naming Speed Test, described earlier, except words are used instead of pairs of letters, e.g., Aa (SAME), Ba (DIFFERENT), etc. In order to pass this Speed Test 1000, students must get at least 9 of the 10 words correct, and they must finish in a limited amount of time, as set by their score on the Naming Speed Test 106, NST and coefficient. This time limit coefficient is initially determined from the NST, but it is adjusted later based upon the student's later performance during the tutoring. That is, when students pass the Speed Test 1000 in less than 2 tries, and if they finish much faster than required, then they can be given slightly less time on the next set of 10 words in order to pass the Speed Test 1000. If they require more than 2 tries to pass, then they can go slightly slower on the next set of 10 words and still pass the speed test 1000.

When the Speed Test 1000 on Part 1 is passed, the student goes on to the 10 words in Part 2 of this 50-word list L. The cycle described for Part 1, above, is repeated for Part 2, Part 3, Part 4, and Part 5. Then the spelling test 702 again is given for all 50 words. If 90% are not spelled correctly (45 or more), then the student must go back and work on the spellings of the missed words until the test is passed by getting 90% correct, just like described earlier for the 10 words in Part 1. When the Spelling Test 702 on the 50 words is passed, then a vocabulary test 900 is given on all 50 words to make sure the student does know their meanings. Each of the words missed on the vocabulary test 900 have to be learned before the student continues. During this vocabulary learning 910, the definitions of the words are given, the words are used in example sentences, and synonyms are given for the words, see FIG. 6 for example. Then, a vocabulary test 912 on these missed words is given again. This cycle is repeated until 90% of the unknown words are answered correctly on the vocabulary test 912. Then, the student goes on to the Speed Test 1000 on all 50 words. This time, all 50 words can appear on the screen 400 and 25 are spelled incorrectly by changing one letter. A practice test can be given first to familiarize the student. The student must get 90% correct and fmish within the time limit in order to pass. It should also be noted that all of the words that were unknown, i.e., missed on the first vocabulary test 912 of 50 words, will be reviewed later (after 5 more lists of 50 words have been completed).

When the Speed Test 1000 on all 50 words is passed, it is reasonable to assume that at least 45 of the 50 words have been raudamatized. This assumption seems reasonable because (a) the student probably knows the meanings of at least 45 of the 50 words, (b) the student probably can spell at least 45 of the 50 words accurately (from the 90% criterion on the Spelling Test), and (c) the student probably can recognize 45 of the 50 words accurately and quickly, at the normal reading rate of the student (from the criterion for passing the Speed Test). Once the above raudamatization criteria have been reached (by passing the Spelling Test 700, Vocabulary Test 900, and Speed Test 1000 on all 50 words in the list), then the Spelling Tutor 300 goes on to the next list L of 50 words—which would be List 32 for the example student, Jose. The Spelling Tutor 300 repeats this same cycle for each successive list of 50 words until the students have learned to read all the basic words they know when listening, which would be Lists 1 through 60 for Jose in the above example. When Jose has worked on, and passed Lists 31 through 60, then at this point, he becomes a Type II Reader and is therefore no longer a Type I Reader. Therefore, Jose would start working on List 61 in the Vocabulary Tutor 500 of the program.

Vocabulary Tutor for Type II Readers.

Remember that a poor reader has low reading achievement and a Poor Type II Reader knows as many words when reading as when listening. Poor Type II Readers need to learn the meaning of more words so they can then be raudamatized by learning to recognize them accurately and quickly in print.

In the last section, the Spelling Tutor 300 was described. The Spelling Tutor 300 includes a vocabulary learning loop 900 portion; however, the vocabulary loop 900 is minor because most students will know the meaning of almost all the words on the lists administered by the Spelling Tutor 300. The vocabulary tutor 500 provides the instruction appropriate for Poor Type II Readers. In the example given earlier for Jose, he would work on the Spelling Tutor 300 until he passed List 60. At that point, he would start on the Vocabulary Tutor 500 on List 61 because he would have learned to read all the basic words he knew when listening. He would make no further progress in reading achievement until he started learning the meaning of the basic words in Lists 61 and higher. So, Jose would start the Vocabulary Tutor 500 on List 61.

The Vocabulary Tutor 500 begins by helping students learn the meaning of the 50 words in a list L. These 50 words are broken down into 5 parts of 10 words each and a 6^{th} part P containing all 50 words, as described earlier for the Spelling Tutor 300. It should be noted that the Vocabulary Tutor 500 cannot start earlier than List 21; there is no Vocabulary Tutor 500 for Lists 1-20. It was assumed that students who do not know the meanings of the first 1000 basic words (Lists 1-20) could not learn their meanings by reading definitions, example sentences, and synonym sentences.

When the Vocabulary Tutor 500 starts, the computer 402 pronounces the first word and it also appears at the top of the screen 400; below the word are a definition sentence, an example sentence, and a synonym sentence. See the example in FIG. 6 for the target word “soak.”

Notice that the target word appears first at the top of the screen 400, e.g., “soak;” it is also pronounced by the computer 402. Then, the definition 520 of the target word is given next. After the definition, the target word is used in an example sentence 530. Next, one or more synonyms 540 are given for the target word. When students finish reading the definition sentence 520, the example sentence 530, and the synonym sentence 540, they click on the NEXT button at the bottom of the screen 400; then, the next target word is presented in a similar manner. This learning cycle is repeated until all 10 words in Part 1 are presented. Then, a vocabulary test 802 is given on the 10 words in Part 1. This vocabulary test 802 consists of a blank 814 where the target word would be (a) in the definition sentence, (b) in the example sentence, or (c) in the synonym sentence. Below the test sentence 812, the student is presented a list of possible words 816 that can contain all 10 words and must click on the one that belongs in the blank 814. See the example of a test item for “soak” in FIG. 8a.

When the Vocabulary Test 802 is completed, the student must have gotten 9 of 10 correct in order to pass. When two or more words are missed, then the student must learn in learning step 806 to spell the ones that are missed using the same procedures as described earlier in the Spelling Tutor 300. Then, the definition 520, example 530, and synonym 540 sentences are presented again for the words that were missed. Next, the vocabulary questions are given again for the ones that are missed, and this cycle is repeated until all of the words missed on the Vocabulary Test 802 are answered correctly. Then, the Vocabulary Test 802 is given again. It should be noted that each time the vocabulary test 802 is given, it can randomly determined whether the definition sentence 520, the example sentence 530, or the synonym sentence 540, will be used as the vocabulary test question for each target word. This means that the Vocabulary Test 802 on each 10 words changes each time it is given. The above cycle can be repeated over and over until the Vocabulary Test 802 is passed.

When the Vocabulary Test 802 on Part 1 is passed, then the student must learn to spell each word and recognize each word quickly using the Spelling Tutor 300 described in the last section. That is, the Vocabulary Tutor 500 automatically includes the Spelling Loop 700 and the Speed Test 1000, as described earlier. After the Spelling loop 700 and the Speed Test 1000 on Part 1 are passed, then the Vocabulary Tutor 500 goes on to the next 10 words in Part 2. That is, this cycle described for Part 1 is repeated for the 10 words in each of Parts 2, 3, 4, and 5. Then, the vocabulary loop 900 gives the vocabulary test 802 on all 50 words in the list; however, only the synonym sentence questions are on this 50-word vocabulary test 802. For any words missed on the 50-word vocabulary test 802, the same learning cycle is repeated as was described. When 90% of the questions on the missed words are answered correctly, then the vocabulary test 802 is passed. Then, the student is given the Spelling test 702 of FIG. 7 for these 50 words. The Spelling loop and the Speed loop of the Spelling Tutor is automatically part of the Vocabulary Tutor 500 so the student always goes on to the Spelling loop 700 for a list after the Vocabulary Test is passed on that list. When both the Spelling loop 700 FIG. 5 and the Speed loop 1000 FIG. 5 for a 50-word list are passed, then it is assumed that the student has raudamatized at least 45 of the 50 words in the list. The Vocabulary Tutor 500 then goes on to the next list of 50 words for the student to work on. All of the words that were missed on the first vocabulary test will be reviewed later in vocabulary loop 900.

The program has been described as an all-English program for use by normal and poor-reading students in schools and home-schooling. The program may also be constructed with foreign language instructions and English content to teach English Language Learners. The program may also be constructed with English instructions and foreign language content to teach students of a foreign language. The program may also be implemented entirely in a foreign language, or using two non-English languages.

The program may be implemented as an application for a stand-alone computer 402, or it may be implemented using an application server and database server with service provided over a network such as the Internet 420. Student records may be created and maintained on a database or application server in network 420.

The user of the method in schools will decide which students will be tutored. It could be determined by the principal, for example, that all sixth graders in a school will be tutored by the method in a computer laboratory. Or, it could be determined by a reading specialist, for example, that all poor readers referred by teachers will be tutored by the method using computers in a special classroom. Or, teachers with computers in their own classrooms could decide which students will receive tutoring during the school day. Or, a service agency (or foundation) could decide to provide tutoring for any student who wants it after school or on Saturdays in a rented computer laboratory. Or, the three placement tests that are given at the beginning of the method could be administered to all the students in a classroom, and then the students whose scores are the lowest could be tutored by the method. It could also be decided by school personnel that the students with the lowest reading achievement test scores will be tutored by the method and existing test scores could be used.

Although the invention has been described in connection with the preferred embodiment, those skilled in the art will appreciate that adaptations may be made thereto without departing from the spirit of the invention as set forth in the following claims:

1. A method of teaching readers including the steps of;
providing a placement test through a computer,
providing a set of word lists containing basic reading words,
setting a starting word list value based on the results of the placement test,
comparing a vocabulary score to a spelling score to determine a comparison;
determining a tutor program to present through the computer based on said comparison and;
presenting the tutor program for the words in said starting word list.

2. The method of claim 1 wherein the tutor program includes a vocabulary loop, a spelling loop and a speed test applied to said word list and wherein a speed coefficient determines a test time allowed on the speed test and wherein said speed test results determine the value of said coefficient applied to a next word list.

3. The method of claim 1 wherein the method occurs through a computer network.

4. The method of claim 1 wherein the step of determining a tutor program includes presenting a spelling tutor if said vocabulary score exceeds said spelling score.

5. The method of claim 1 wherein said step of presenting the tutor program is followed by indexing the starting word list value to a value indicating a next list of words to present.

6. The method of claim 1 wherein the step of providing a placement test includes providing a placement spelling test to determine a spelling start list value, a placement listening vocabulary test to determine a vocabulary start list value and a naming speed test.

7. The method of claim 1 wherein the tutor program includes a vocabulary learning sequence if said spelling score is not less than said vocabulary score.

8. The method of claim 4 wherein the step of presenting a spelling tutor includes a computer reading at least one word from said word list and asking a student to input a spelling using an input device.

9. The method of claim 7 wherein said vocabulary learning sequence includes said computer presenting a word from said list, a definition of the word and a sample of the word used in a sentence on an output device of said computer.

10. The method of claim 9 wherein said vocabulary learning sequence is followed by the steps of presenting a vocabulary learning test to test the student's knowledge of the word from the list.

11. A method of teaching reading skills including;
providing a placement test to determine a student's spelling score and vocabulary score and to test the naming speed of the student,
setting a speed coefficient for the student based on results from the placement test, providing a set of word lists,
selecting a word list from said set of word lists based on the results of the placement test, comparing the vocabulary score to the spelling score to determine a comparison;
determining a teaching tutor program to present through the computer based on said comparison and;
presenting the teaching tutor program for the words in said word list.

12. The method of claim 11 wherein if said vocabulary score exceeds said spelling score, the teaching tutor program includes the step of said computer displaying and reading aloud at least a word from said word list to teach the spelling of the word wherein the reading includes displaying the word and displaying the word divided into syllables.

13. The method of claim 12 wherein said step of displaying and reading is followed by a step of spelling testing wherein the computer reads the word aloud and asks the student to input a spelling for the word.

14. The method of claim 13 wherein the step of spelling testing is followed by a step of vocabulary testing.

15. The method of claim 14 wherein the step of vocabulary testing includes the step of the computer displaying a sentence with at least one word left blank and said computer asking the student to input the correct word to fill the blank.

16. The method of claim 11 wherein if said spelling score exceeds said vocabulary score the teaching tutor program includes the step of said computer displaying a word from said word list and the step of presenting a definition of the word and an example of using the word in a sentence.

17. The method of claim 16 wherein said step of presenting a definition of the word from said word list is followed by a vocabulary test step of asking the student to pick a correct word to fill in a blank in a sentence.

18. A computerized educational method of teaching reading skills to a student including;
providing a placement test through a computer wherein the step of providing a placement test includes providing a spelling test to determine a spelling score; and providing a listening vocabulary test to determine a vocabulary score,
setting a speed coefficient for the student,
providing a set of word lists,
selecting a first possible word list from said set of word lists based on the spelling score, selecting a second possible word list from said set of word lists based on the vocabulary score,
comparing the listening vocabulary score to the spelling score to determine a comparison; selecting a starting word list from one of said first and second possible word lists based on said comparison;
determining a teaching tutor program to present through the computer based on said comparison and;
presenting the teaching tutor program for the words in said starting word list.

19. The educational method of claim 18 wherein if said vocabulary score exceeds said spelling score, the teaching tutor program includes a spelling tutor where said spelling tutor includes the steps of;
the computer displaying and reading aloud all words in the starting word list,
testing for the spelling of all words on the starting word list,
teaching any mis-spelled words and then displaying the word, its definition and an example of the word used in a sentence.

20. The educational method of claim 18 wherein the vocabulary test measures listening vocabulary by reading aloud target words and a choice of synonyms and asking the student to identify the target word.

21. The educational method of claim 18 wherein a naming speed test presents pairs of symbols in combination of upper and lower case and asks the student to identify if the symbols have the same or different meaning.

22. The educational method of claim 21 wherein a speed loop tests word recognition for words on said starting word list by comparing student recognition time for the word to the student's time in said naming speed test.

23. The educational method of claim 18 wherein a speed loop teaches rapid word recognition by presenting said word list with some words from said word list altered, and asking a student to distinguish those words that have been altered

24. An computerized educational apparatus for teaching reading skills comprising; a computer containing a plurality of word lists;
a placement test including an assessment of spelling and vocabulary skills;
a comparator to compare a starting spelling score to a starting vocabulary score;
a memory to store the results of the comparator;
said computer selecting a starting word list from said plurality of word lists stored in a database based on the comparison results stored in said memory;
said computer selecting a teaching tutor program based on the comparison stored in said memory and presenting a teaching tutor program through a computer display for said starting word list.

25. The educational apparatus of claim 24 wherein if said vocabulary score exceeds said spelling score, the teaching tutor program includes a display of at least one word from said starting word list and wherein said computer reads aloud said at least one word from said word list to teach the spelling of the word.

26. The educational apparatus of claim 22 wherein after teaching the word the computer reads the word aloud and asks the student to input a spelling for the word using an input device.

27. The educational apparatus of claim 22 wherein if said spelling score exceeds said vocabulary score, the teaching tutor program includes a display of the at least one word from said starting word list and includes a display of said at least one word used in a sentence and a display of a definition sentence.
